(19) United States
(12) Patent Application Publication
(10) Pub. No.: US 2012/0142809 A1
(43) Pub. Date: Jun. 7, 2012

(54) INK JETTABLE, RADIATION CURABLE, FLUID COMPOSITIONS, PRODUCTION METHODS, AND RELATED SUBSTRATES

(76) Inventors: MICHAEL V. OBERSKI, Ann Arbor, MI (US); HUILEI ZHANG, Ypsilanti, MI (US)

(21) Appl. No.: 12/958,277

(22) Filed: Dec. 1, 2010

(51) Int. Cl. C08J 3/28

(52) U.S. Cl. 522/152; 522/154

(57) ABSTRACT

A radiation curable ink composition comprising a color base, one or more stabilizers and one or more surfactants, one or more photoinitiators, and a reactive component. The reactive component includes at least one monofunctional monomer including at least one aromatic constituent of greater than 5 weight percent, at least one monofunctional component with vinyl functionality, and an oligomer. Other aspects include a process for curing ink of such a composition, and a substrate prepared by such a process. Some benefits of this particular composition of ink include improved flexibility, better adhesion, and expedited curing.

### BACKGROUND

1. Field of the Invention

This invention relates to ink jettable, radiation curable, fluid compositions incorporating a radiation curable diluent, an oligo/resin, and optional additives such as colorants, photoinitiators, and the like. The compositions of this invention provide particular advantages in the areas of flexibility, adhesion, and curing speed.

2. Description of the Related Art

Generally, during ink jet printing, ink is ejected onto a substrate in controlled patterns of closely spaced dots to produce printed text, graphics, holograms, and other images.

Both solvent-based and radiation-curable inks are currently available for ink jet printing. Ink jet printing with aqueous-based or organic solvent-based formulations generally includes a drying operation during which the water or organic solvent present in a deposited fluid ink dot is evaporated, leaving a solid print residue on the substrate. While organic solvents generally have high vapor pressures and are easily evaporated during drying, they pose environmental, safety or health hazards and often require special handling. Water-based inks are safer to use; however, drying such inks generally is more energy-intensive.

Radiation curable inks are hardened by exposure to radiation. To address drying-related problems described above, these inks generally are formulated to minimize and preferably eliminate the use of non-reactive diluents. For example, several existing radiation curable inks have been formulated to rely on reactive diluents, such as functionalized monomers that, together with other ingredients, crosslink to form the printed image.

Radiation curable inks are printed onto numerous substrates, both rigid and flexible. These include polymeric substrates, such as various types of PVC as well as polystyrene (usually modified), polycarbonate, acrylonitrile-butadiene-styrene (ABS), polyolefines, polyesters, and others. The appearance of the printed image is affected by jettable characteristics of the ink, such as ink viscosity, droplet formation, satellite formation, drying or curing time and other properties that relate to the ejection of the ink from the print head, droplet travel and impact onto substrate.

Various inkjet printers have used arc lamps to cure the ink, thereby reducing the time for the printed product to be handled, applied, manipulated, etc. Basically, radiation from such arc lamps reacts with photoinitiator chemicals in the ink to generate radicals, initiate polymerization in the ink, and change the ink from liquid to solid form. The light from these arc lamps includes some ultraviolet (UV) radiation and a substantial component of infrared radiation (IR). Using arc lamps to cure materials has a number of disadvantages.

First, the spectral output varies in type as well as intensity as the bulb ages. The degradation is also not predictable in some cases as use can influence how the bulb degrades. Bulbs are often doped with materials such as iron gallium, etc. As a doped bulb ages, the spectral output will eventually revert back to a state that is consistent with a straight mercury bulb. Also, over time, and as the bulb is lit and re-lit, this causes irreversible degradation of the bulb and output in terms of intensity; and it will degrade over time. Further, bulbs can degrade unpredictably depending on how many times they are cycled on and off. Thus conventional curing bulbs have a use life around one thousand hours.

Second, a large majority of the output is expressed as IR radiation, not UV. With these type of lamps, thermally sensitive substrates cannot be run, such as thin gauge styrene, cardboard, polybanner, etc. The heat either warps or distorts the substrate causing head strikes as the carriage scans the media. Further, the buildup of heat due to the output of IR needs to be managed somehow in the machine. As the platen heats up, media handling becomes more difficult to control. Costly systems need to be implemented to manage the heat to ensure consistent media handling, with one example including use of a chilled platen.

Consequently, there has been a move in the printing industry to use light emitting diodes (LEDs), which output a carefully selected bandwidth of radiation. Such. LEDs can be selected so that their output is entirely UV without any IR component whatsoever. This helps avoid unwanted heating of the substrate.

Despite the foregoing benefits, the LED curing process has its own issues. For one, LEDs typically provide a low power output. In some configurations, this can immobilize the drops of ink without fully curing them.

Therefore, the design teams working on ink jet printers are still faced with the constant challenge of improving the ink composition to expedite curing. The difficulties of this challenge are compounded since designers must also achieve progress as to properties of flexibility, adhesion, and weather resistance.

### SUMMARY

A radiation curable ink composition comprising a color base, one or more stabilizers and one or more surfactants, one or more photoinitiators, and a reactive component. The reactive component includes at least one monofunctional monomer including at least one aromatic constituent of greater than 5 weight percent, at least one monofunctional component with vinyl functionality, and an oligomer. Other aspects include a process for curing ink of such a composition, and a substrate prepared by such a process. Some benefits of this particular composition of ink include improved flexibility, better adhesion, and expedited curing.

### BRIEF DESCRIPTION OF THE DRAWINGS

FIGS. 1-3 are tables showing some exemplary ink compositions.

FIG. 4 is a flowchart of an operational sequence for applying and curing ink.

Composition

One aspect of this disclosure is an ink jettable radiation curable ink. The ink compositions described herein include several chemical compounds. Compounds that share a property or a function in the described ink compositions are collectively referred to as a component.

Among the materials generally present in the formulations described herein, the ink compositions may include radiation curable monomers or oligomers that participate in crosslinking reactions. Crosslinking reactions take place, for instance, via cationic or free radical mechanisms, during radiation-curing of the ink and result in a hardened material, such as print on a substrate.

As used herein, monomer refers to a material that has an average molecular weight that is less than about 400 grams per mole (g/mole). Oligomer refers to relatively intermediate molecular weight materials, having an average molecular weight of at least about 400 g/mole and generally not higher than about 100,000 g/mole.

Curable materials in the described ink compositions are referenced herein by their functionality. Those radiation curable monomers or oligomers that share the same functionality are referred herein as a component that has that functionality. The term functionality refers to a chemical group, bond or moiety that is capable of participating in a crosslinking reaction when exposed to curing energy.

In one embodiment, an ink composition includes one or more reactive components, one or more photoinitiators, a color or pigment base, one or more stabilizers, and one or more surfactants. In one example, the reactive component includes (1) at least one monofunctional monomer including at least one aromatic constituent of greater than 5 weight percent; (2) at least one monofunctional component with vinyl functionality, and (3) an oligomer.

In an embodiment, the at least one monofunctional monomer may include an aromatic constituent, and in a further embodiment, greater than 5 weight percent of an aromatic constituent. In a further embodiment, the aromatic constituent forms 15 to 50 weight percent, and in a further embodiment, 30 weight percent. In an embodiment, the aromatic constituent comprises 2-phenoxyethyl acrylate, with some examples including 15 to 50 weight percent, and in a further example, about 30 weight percent, and in a further example 32.4 to 35.105 weight percent.

In one example, the at least one monofunctional monomer includes zero to 22 weight percent isoborynl acrylate, and in a further embodiment, zero to 15 weight percent isoborynl acrylate.

In an embodiment, the monofunctional component with vinyl functionality may comprise 15 to 35 weight percent comprising N-vinylcaprolactam, and in a further embodiment 25 to 30 weight percent comprising N-vinylcaprolactam.

In an embodiment, the oligomer comprises an aliphatic polyester based urethane diacrylate oligomer, and in a further embodiment, 5 to 20 weight percent of the aliphatic polyester based urethane diacrylate oligomer, and in a further embodiment, 9 to 16.2 weight percent.

In an embodiment, the ink composition is free of any multifunctional monomers.

Ink Composition—Specific Examples

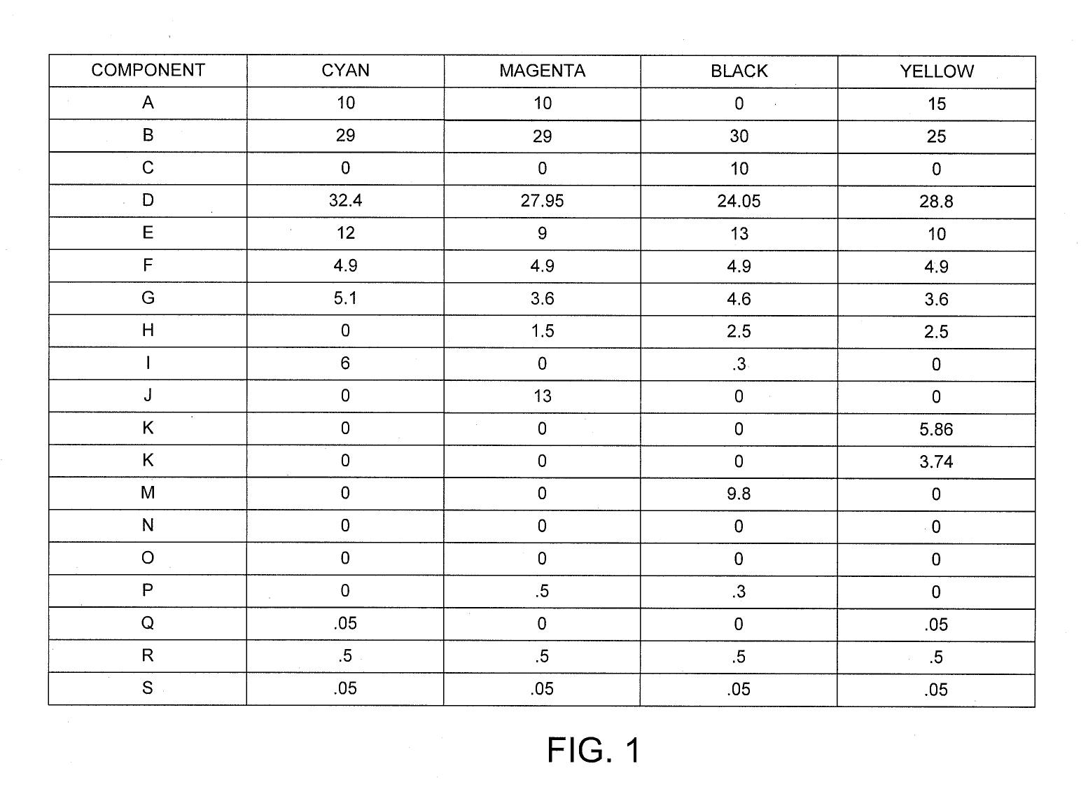

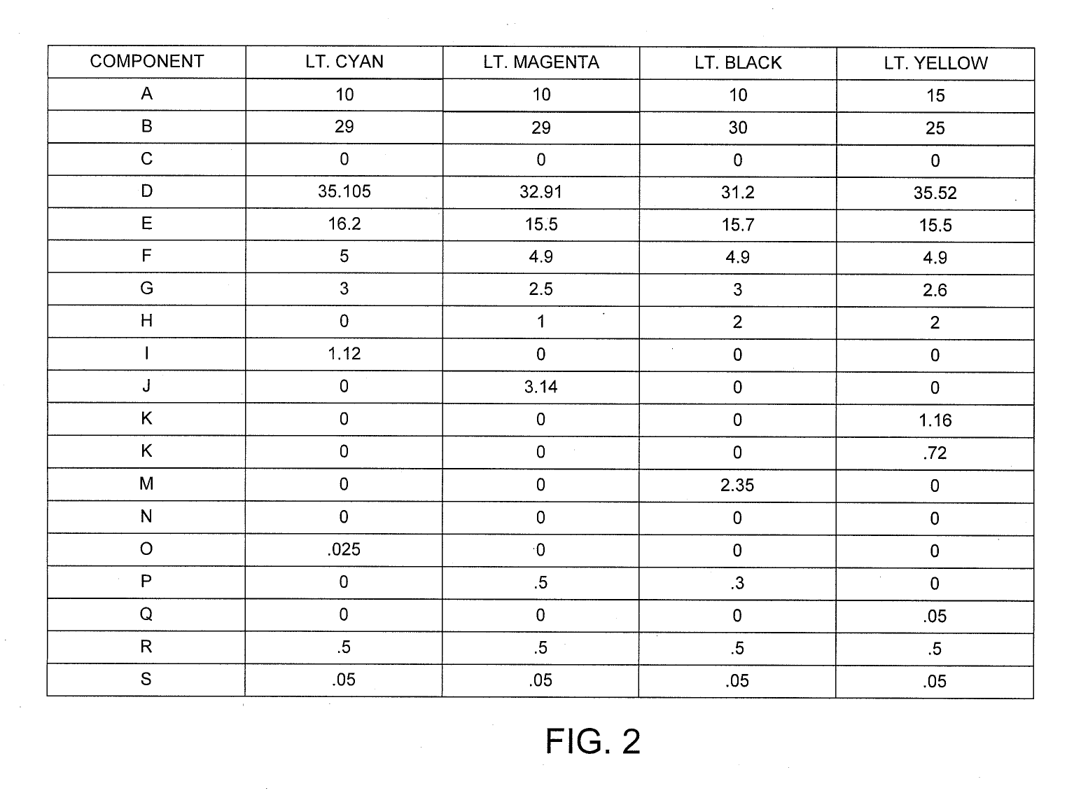

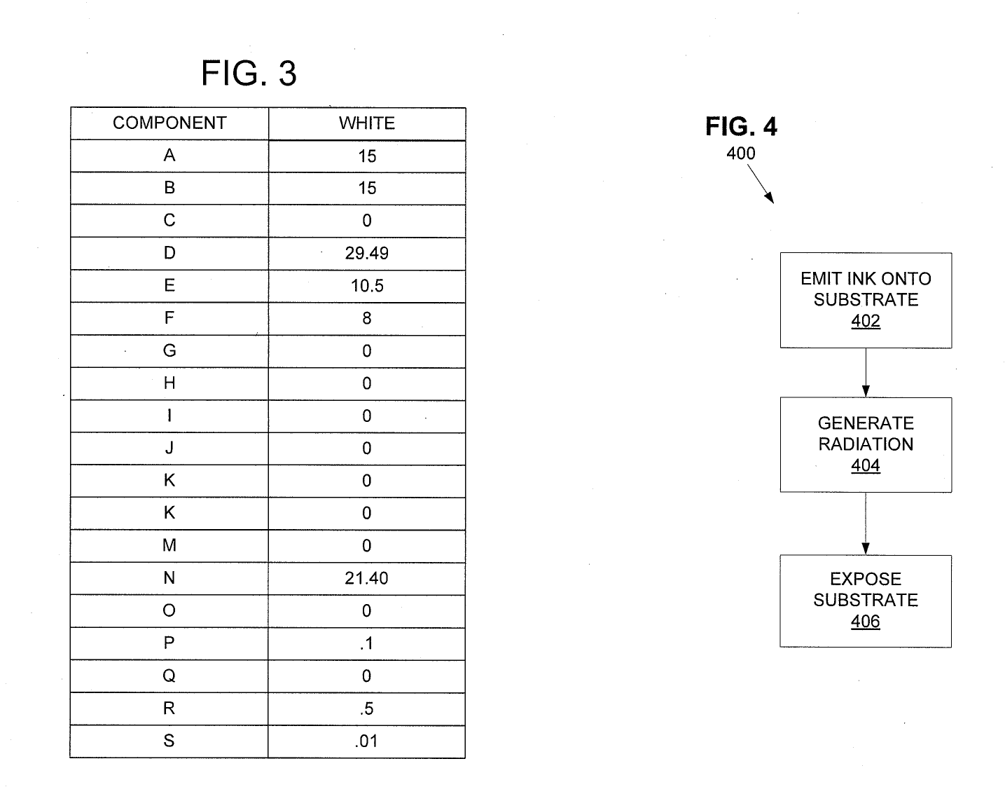

Without any intended limitations, the tables in FIGS. 1-3 provide some specific examples of ink compositions. Different examples are given for different colors, including cyan, magenta, black, yellow, light-cyan, light-magenta, light-yellow, light-black, and white. The components A-S are explained as follows.

Reactive Components

Components A-E form reactive components of the ink composition, which may also be called reactive diluents. These reactive components include functionalized monomers that, together with other ingredients, crosslink to cure the printed image.

Component A comprises a viscosity-lowering reactive component, and more particularly, a cycloaliphatic monomer. In the illustrated examples, this component is isobornyl acrylate (IBOA) such as isobornyl (meth)acrylate. In one example, zero to 22 weight percent isoborynl acrylate is used, and in a further example, zero to 15 weight percent. This component has many useful properties, such as encouraging a fast cure speed.

Component B comprises a multifunctional component with vinyl functionality. In a further example, this includes a viscosity-lowering monofunctional, radiation curable monomer suitable for use as a reactive component. In a further example, this includes N-vinylcaprolactam, also known as V-CAP or VCAP. In an example, 15 to 35 weight percent of N-vinylcaprolactam is used, and in a further example, 25 to 30 weight percent. This monomer and reactive diluent has many useful properties including low viscosity, good solvency, strong adhesion on organic substrates, good reactivity especially concerning surface cure.

Component C comprises an adhesion promoting, reactive monomer such as tetrahydrofurfuryl acrylate, known as THFA. This component has many useful properties, such as low viscosity, good solvency, strong adhesion on organic substrates, good reactivity especially concerning surface cure.

In an embodiment, component D comprises at least one monofunctional monomer including at least one aromatic constituent. In a further example, the aromatic constituent is greater than 5 weight percent, and in a further example, 15 to 50 weight percent, and in a further example, 30 weight percent. In a further example, this includes a low volatility, monofunctional, aromatic monomer. In an embodiment, the aromatic monomer has a viscosity of about 5 to 25 Centipoise at 25 degrees Celsius. A more specific example is 2-phenoxyethyl acrylate, available from Sartomer Company under the trademark SR339™. In one example, 15 to 50 weight percent of 2-phenoxylethyl acrylate is used, and in another example, 32.4 to 35.105 weight percent.

In an alternative embodiment, component D may be implemented by a monofunctional monomer without an aromatic constituent. Some examples include the product CD420™ of Sartomer Company, said to be a very low viscosity monofunctional monomer that brings high Tg and low shrinkage to UV/EB inks. Another example along these lines is cyclic trimethylolpropane formal acrylate, available from Sartomer Company under the trademark SR531™. The SR531™ product is said to be a low viscosity monofunctional acrylate monomer that is used in a variety of UV/EB cured applications including inks.

Components such as the foregoing examples of component D have many useful properties, such as fast cure speed, good adhesion, toughness, flexibility, and non-yellowing.

Component E comprises an oligomer. In a further example, component E includes an aliphatic urethane acrylate, which is an aliphatic polyester based urethane diacrylate oligomer. In one example, the oligomer has a molecular weight exceeding 300 grams/mol. In an example, the oligomer of component E comprises 5 to 20 weight percent of aliphatic polyester based urethane diacrylate oligomer, and in a further example, 9 to 16.2 weight percent. In an example, the oligomer includes the CN991™ product available from Sartomer Company. This component has many useful properties, such as improved cure speed and achieving finished film properties such as rigidity.

Photoinitiators

Ink colorants absorb part of the incident radiation, and may therefore depleting the available energy to activate the photoinitiators. This may slow down the curing rate and may result in poor through and/or surface cure of the applied ink. To avoid this, the exemplary ink composition uses a mixture of photoinitiators in order to provide both surface and through cure.

Components F-H are photoinitiators. In this example, component F comprises the a phosphine oxide such as the Genocure TPO™ product available from Rahn corporation, and component G comprises a Bis Acryl Phosphine Oxide (BAPO) type of photoinitiator such as Irgacure 819™ product from Ciba corporation. In the illustrated example, component H also comprises a photoinitiator. One commercially available example is the Genocure DETX™ product available from Rahn corporation.

Pigment Base

Components I-N are pigment bases or colorants. The pigment used in the ink composition provides the desired color. In one example, the ink compositions herein use durable pigments, meaning that they have good outdoor durability and resist fading upon exposure to sun and the elements.

Pigments useful in the described ink compositions may be organic or inorganic. Suitable inorganic pigments include carbon black and titania, while suitable organic pigments include phthalocyanines, anthraquinones, perylenes, carbazoles, monoazo- and disazobenzimidazolones, isoindolinones, monoazonaphthols, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides, anthrapyrimidines. Organic pigments will be differently shaded, or even have different colors, depending on the functional groups attached to the main molecule, as will be apparent to those of ordinary skill in the art, having the benefit of this disclosure. Further, many organic and inorganic pigments suitable for ink jet printing should be apparent to ordinarily skilled artisans having the benefit of this disclosure.

The pigment is generally incorporated into the ink composition by milling the pigment into selected reactive monomers and optional oligo/resin materials. If a colorant in the form of pigment is used, a dispersant may be desired in some instances in order to stabilize the pigment. The use and incorporation of pigments into relevant ink compositions is well known in the relevant art.

Component I comprises a cyan pigment base. Component J comprises a magenta pigment base. Component K comprises a benzimidiazolone yellow (PY120) pigment base. Component L comprises an isoindolinone yellow (PY110) pigment base. Component M comprises a black pigment base. Component N comprises a white pigment, such as the Kemira RDI-S alumina surface treated rutile titanium oxide pigment available from Kemira Pigments Oy of Helsinki Finland.

Stabilizers

Components O-Q comprise various stabilizers. To enhance durability of a printed image graphic, especially in outdoor environments exposed to sunlight, a variety of commercially available stabilizing chemicals can be added optionally to the inks described herein. These stabilizers can be grouped into the following categories: heat stabilizers, ultra-violet light stabilizers, and free-radical scavengers.

In the illustrated example, component O comprises a stabilizer such as Butylated Hydroxytoluene (BHT). The beneficial properties of this component include providing anti-oxidant and stabilization.

Component P comprises a photoinitiator and polymerization inhibitor such 2-Phenoxy Ethoxy Acrylate, which is commercially available in the product Firstcure ST-1™ from Albemarle corporation. The beneficial properties of this component include in-can stability.

Component Q comprises an oxidation inhibitor. A commercially available example is the Ethanox 4740™ product from Albemarle corporation. The beneficial properties of this component include promoting shelf stability to prevent degradation such as formation of radicals.

Surfactants

Components R-S are surfactants. Component R comprises a flow control additive or leveling agent such as an acrylic leveling polyacrylate. A commercially available example is the BYK 361N™ product from BYK Additives and Instruments. The beneficial properties of this component include improved leveling and gloss.

Component S comprises a surface tension reducing additive such as BYK 377™ product from BYK Additives and Instruments.

Viscosity

Without any intended limitation, the following example shows the viscosity of each ink composition of FIGS. 1-3 at 45 degrees Celsius. The units are Centipoise. Cyan 11.9, magenta 12.5, black 11.8, yellow 12.0, light cyan 11.9, light magenta 12.2, light yellow 12.0, light black 12.1, white 12.7.

Ink Preparation

Generally, commercially available materials may comprise some or all materials in the described ink compositions. Ink compositions are prepared by combining these materials in a single step or in several steps.

In an example, known mixing techniques can be employed. For example, all ingredients may be combined in one step and blended, stirred, milled, or otherwise mixed to form a homogeneous composition. In another embodiment, at least some radiation curable compounds are blended together, with the remaining constituents being incorporated into the resulting composition via blending, milling, or other mixing technique.

In one example, an ink composition is prepared by adding the pigment slurry first. High viscosity components are added next, followed by the lower viscosity components. Components need not be added in descending order of viscosity, only those that are notably higher are preferably added first. Initiators may be added last to discourage curing of the ink during processing.

Operating Sequence

FIG. 4 shows an exemplary operating sequence 400 to apply ink to a substrate. In step 402, one or more printer heads of an ink jet printer emits ink onto a sheet of substrate. One exemplary printing system is the EFI-Jetrion™ model 4000 printer, but a variety of other EFI™ printers may be used, as well as ink jet printing systems from other manufacturers such as Agfa, Mimaki, Inca, Durst, Leggett, Platt, and the like.

Step 404 generates radiation using an array of light emitting elements. In this example, LEDs are used to generate UV radiation. Thus, wavelength can be carefully controlled by selection of the LEDs. In one example, ink compositions are cured using UV light that is actinic, for example light having a range of wavelengths centered on or about 395 nm, plus or minus ten percent. Depending upon the particular substrate and ink, other examples in the UV range may used, such as 365 nm, 385 nm, etc. In one example, irradiance “at the glass,” corresponding to a working distance of zero, is on the order of 7 watts/cm². Working distance for the LED array is on the order of 1-2 mm from the surface of the substrate, in one example. Steps 402-404 may occur in serial, as shown, or they may occur at the same time.

Step 406 exposes the substrate to the radiation. The present ink composition is suitable for application to a variety of different rigid or flexible substrates, both porous and non-porous, such as signs, motor vehicles, aircraft, vessels, furniture, buildings, equipment, and the like. Without any intended limitation, some exemplary substrate materials include vinyl, polypropylene, polycarbonate, and the like. Optionally, the substrate may be primed for printing using techniques known in the art.

Step 406 occurs after step 402, but may occur concurrently with step 404. In one example, step 406 changes the relative position of the LEDs and substrate, moving one or both, by way of a conveyor, various rollers, or any other appropriate mechanism. The LED array may be built-in to the printer or the array may be a separate component. The ink begins to cure during step 406. The ink may completely cure during or shortly after step 406.

Ink Properties

There are numerous beneficial properties of this particular ink composition. Some benefits include improved flexibility, better adhesion, expedited curing, and better resistance to weathering.

An exemplary ink composition according to an example of this disclosure was prepared, jetted, and cured with a conventional arc lamp on a vinyl substrate. Separately, an exemplary ink composition was also prepared, jetted, and cured via LED on a vinyl substrate. Aged flexibility tests on the printed material showed a significant increase in flexibility for the LED-cured sample compared to the arc-lamp-cured sample.

There are many differences when comparing LED curing to a conventional arc lamp curing. LED curing offers a narrower spectrum, and a higher intensity of radiation at this particular band. Furthermore, polymerization occurs at a lower temperature with LED during, since there is no IR radiation. Without intending to be bound by a mechanism of action, it is believed that LED curing produces a polymer with different morphology when compared to a conventional arc lamp resulting from some or all of the foregoing differences. Thus the performance of the cured ink film is different, and as tested, demonstrates significant improvement.

Aside from flexibility, the LED cured sample demonstrated satisfactory surface cure at printer speeds up to 72 inches per second. The resultant film exhibited adherence to a variety of substrates.

### OTHER EMBODIMENTS

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the invention, and the scope of the invention fully encompasses other embodiments which may become obvious to those skilled in the art, and that the scope of the invention is accordingly to be limited by nothing other than the appended claims.

The claimed invention is:

1. An ink jettable radiation curable ink composition, comprising:
(a) a color base;
(b) one or more stabilizers and one or more surfactants;
(c) one or more photoinitiators; and
(d) a reactive component comprising:
(i) at least one monofunctional monomer including at least one aromatic constituent of greater than 5 weight percent;
(ii) at least one monofunctional component with vinyl functionality; and
(iii) at least one oligomer.

2. A process of curing ink, comprising:
causing light emitting diodes to generate radiation occurring in a predetermined range of wavelengths; and
exposing a substrate bearing ink to the generated radiation;
where the ink comprises the composition of claim 1.

3. A printed substrate prepared by a process comprising operations of:
causing light emitting diodes to generate radiation occurring in a predetermined range of wavelengths; and
exposing a substrate bearing ink to the generated radiation;
where the ink comprises the composition of claim 1.

4. The invention of claim 1 or 2 or 3, where the at least one aromatic constituent comprises 15 to 50 weight percent.

5. The invention of claim 1 or 2 or 3, where the at least one aromatic constituent comprises about 30 weight percent.

6. The invention of claim 1 or 2 or 3, where the at least one aromatic constituent comprises 15 to 50 weight percent 2-phenoxyethyl acrylate.

7. The invention of claim 1 or 2 or 3, where the at least one aromatic constituent comprises 32.4 to 35.105 weight percent 2-phenoxyethyl acrylate.

8. The invention of claim 1 or 2 or 3, where the composition is free of multifunctional monomers.

9. The invention of claim 1 or 2 or 3, where the at least one monofunctional monomer comprises zero to 22 weight percent isobornyl acrylate.

10. The invention of claim 1 or 2 or 3, where the at least one monofunctional monomer comprises zero to 15 weight percent isobornyl acrylate.

11. The invention of claim 1 or 2 or 3 where the color base includes one or more components of a black colorant, and the at least one monofunctional monomer is free of isobornyl acrylate, and the reactive component includes about 10 weight percent tetrahydrofurfuryl acrylate.

12. The invention of claim 1 or 2 or 3, where the at least one monofunctional component with vinyl functionality comprises 15 to 35 weight percent comprising N-vinylcaprolactam.

13. The invention of claim 1 or 2 or 3, where the at least one monofunctional component with vinyl functionality comprises 25 to 30 weight percent comprising N-vinylcaprolactam.

14. The invention of claim 1 or 2 or 3, where the at least one oligomer comprises 5 to 20 weight percent an aliphatic polyester based urethane diacrylate oligomer.

15. The invention of claim 1 or 2 or 3, where the at least one oligomer comprises 9 to 16.2 weight percent an aliphatic polyester based urethane diacrylate oligomer.

16. The invention of claim 2 or 3, where the predetermined range of wavelengths is between about 200 and 400 nanometers.

17. An ink jettable radiation curable ink composition, consisting essentially of:
(a) a color base;
(b) one or more stabilizers and one or more surfactants;
(c) one or more photoinitiators; and
(d) a reactive component comprising:
(i) at least one monofunctional monomer including at least one aromatic constituent of greater than 5 weight percent;
(ii) at least one monofunctional component with vinyl functionality; and
(iii) at least one oligomer.
